(19) United States
(12) Patent Application Publication
(10) Pub. No.: US 2015/0324580 A1
(43) Pub. Date: Nov. 12, 2015

(54) APPARATUS AND METHOD FOR ANALYZING MALICIOUS CODE IN REAL ENVIRONMENT

(71) Applicant: ELECTRONICS AND TELECOMMUNICATIONS RESEARCH INSTITUTE, Daejeon (KR)

(72) Inventors: Sang Rok LEE, Daejeon (KR); Jung Min KANG, Daejeon (KR); Jung Sun KIM, Daejeon (KR); Cheol Ho LEE, Daejeon (KR); In Sook JANG, Daejeon (KR)

(21) Appl. No.: 14/474,226

(22) Filed: Sep. 1, 2014

(30) Foreign Application Priority Data
May 12, 2014 (KR) 10-2014-0056209

(51) Int. Cl. G06F 21/52

(52) U.S. Cl. CPC G06F 21/52

(57) ABSTRACT

An apparatus and method for analyzing malicious code in a real environment are provided. The apparatus for analyzing malicious code in a real environment includes a storage unit, a VHD control unit, and an analysis unit. The storage unit stores an original virtual hard disk (VHD) and a child VHD. The VHD control unit performs booting using an uninfected clean VHD. The analysis unit executes an object of analysis after the booting, generates the first results of the analysis based on static, dynamic and state analyses, generates the second results of the analysis by comparing the state of an infected VHD with the state of the clean, generates the results of malicious code analysis based on the first results of the analysis and the second results of the analysis, and sends the results of the malicious code analysis to the VHD control unit.

### CROSS-REFERENCE TO RELATED APPLICATION

This application claims the benefit of Korean Patent Application No. 10-2014-0055209, filed May 12, 2014, which is hereby incorporated by reference in its entirety into this application.

### BACKGROUND OF THE INVENTION

1. Technical Field

The present invention relates generally to an apparatus and method for analyzing malicious code in a real environment and, more particularly, to an apparatus and method for analyzing malicious code in a real environment (or in real hardware) using a virtual hard disk (VHD).

2. Description of the Related Art

In the analysis of malicious code, a method using a virtual environment (or a virtual machine) is being widely used.

A virtual environment is advantageous in that the behavior of malicious code can be easily separated from a user environment even when the malicious code has been executed and in that the virtual environment can be easily returned to the original clean environment in order to execute another piece of malicious code after one piece of malicious code has been previously executed. Accordingly, the analysis of malicious code is usually performed using a virtual environment.

As such analysis methods using virtual environments become known, various types of malicious code which recognize virtual environments have been developed. The various types of malicious code operate differently in virtual environments than they do in real environments; which makes it difficult to perform analysis and detection.

Virtual environments used in malicious code analysis systems include VMWare, Virtual-PC, and QEMU/KVM. Malicious code uses various methods of recognizing the virtual environments.

A clear solution to the monitoring and analyzing of the real behavior of malicious code that exhibits such a behavior pattern is to execute malicious code, that is, an object of analysis, in a real environment (i.e., an environment based on real hardware or a bare-metal system).

Nevertheless, there are some problems to be solved in analysis based on a real environment. A representative problem is to efficiently return a dirty analysis environment to a clean environment prior to the execution of new malicious code after the former piece of malicious code has been executed. Most real environment analyses solve this problem via a server-client structure, for example, Pre-boot eXecution Environment (PXE). In this method, the server stores a disk image of the client (i.e., an analysis environment). After booting has been performed over a network, the client receives a clean disk image from the server and then boots an operating system, or uses the depository of the server itself as a disk via ATA-over-Ethernet (AoE).

As a related technology, Korean Patent No. 0927240 (entitled “Malicious Code Detection Method using Virtual Environment”) discloses a technology of performing behavior analysis on a file attached town email using a virtual environment and detecting whether the file is malicious or not.

### SUMMARY OF THE INVENTION

Accordingly, the present invention has been made keeping in mind the above problems occurring in the conventional art, and an object of the present invention is to provide an apparatus and method for analyzing malicious code in a real environment, which are capable of monitoring and analyzing the behavior of malicious code that recognizes an environment as a virtual environment and does not act maliciously therein.

In accordance with an aspect of the present invention, there is provided an apparatus for analyzing malicious code in a real environment, including a storage unit configured to store an original virtual hard disk (VHD) and a child VHD; a VHD control unit configured to perform booting using an uninfected clean VHD, and to output the received results of malicious code analysis to the outside; and an analysis unit configured to execute an external object of analysis after the booting, to generate the first results of the analysis based on static, dynamic and state analyses of the object of analysis, to generate the second results of the analysis by comparing the state of an infected VHD whose state has been infected by the execution of the object of analysis with the state of the clean VHD and then analyzing a change in the state between the infected VHD and the clean VHD, to generate the results of malicious code analysis based on the first results of the analysis and the second results of the analysis, and to send the results of the malicious code analysis to the VHD control unit.

The VHD control unit may be further configured to perform the booting using the clean VHD generated by copying the original VHD when the booting is executed.

The VHD control unit may be further configured to perform the booting using the clean VHD generated by copying the child VHD when the booting is executed.

The VHD control unit may be further configured to store, in the storage unit, the infected VHD whose state has been changed after the execution of the object of analysis in the analysis unit.

The VHD control unit may be further configured to perform restoration to a clean analysis environment using the clean VHD that is generated by copying the original VHD when a new analysis is started by the analysis unit.

The VHD control unit may be further configured to perform restoration to a clean analysis environment using the clean VHD generated by copying the child VHD when a new analysis is started by the analysis unit.

The original VHD may be generated as a fixed or expandable hard disk image type.

The child VHD may be generated as a differencing hard disk image type.

The analysis unit may generate the second results of the analysis based on the change in the state of the infected VHD if the clean VHD is of a differencing hard disk image type when comparing the state of the infected VHD with the state the clean VHD and then analyzing the change in the state between the infected VHD and the clean VHD.

The object of analysis may include one or more of an executable file, an image file, a document file, and a uniform resource locator (URL).

In accordance with another aspect of the present invention, there is provided a method of analyzing malicious code in a real environment, including performing, by a virtual hard disk (VHD) control unit, booting using an uninfected clean VHD; executing, by an analysis unit, an external object of analysis after the booting; generating, by the analysis unit, the first results of the analysis based on the static, dynamic and state analyses of the object of analysis; generating, by the analysis unit, the second results of the analysis by comparing the state of an infected VHD whose state has been infected by the execution of the object of analysis with the state of the clean VHD and also analyzing a change in the state between the infected VHD and the clean VHD; and generating, by the analysis unit, the results of malicious code analysis based on the first results of the analysis and the second results of the analysis.

Performing the booting may include performing the booting using the clean VHD generated by copying an original VHD.

Performing the booting may include performing the booting using the clean VHD generated by copying a child VHD.

The method may further include performing, by the VHD control unit, restoration to a clean analysis environment using the clean VHD generated by copying an original VHD when a new analysis is started.

The method may further include performing, by the VHD control unit, restoration to a clean analysis environment using the clean VHD generated by copying a child VHD when a new analysis is started by the analysis unit.

Generating the second results of the analysis may include generating the second results of the analysis based on the change in the state of the infected VHD if the clean VHD is of a differencing hard disk image type when comparing the state of the infected VHD with the clean VHD and also analyzing the change in the state between the infected VHD and the clean VHD.

In accordance with still another aspect of the present invention, there is provided a method of analyzing malicious code in a real environment, including selecting, by a distributor, any one of a plurality of analysis environment that are real hardware; performing, by the selected analysis environment, booting using an uninfected clean virtual hard disk (VHD); transferring, by the distributor, an object of analysis to the selected analysis environment after performing the booting; generating, by the selected analysis environment, first results of the analysis based on the static, dynamic and state analyses of the object of analysis by executing the object of analysis; sending, by the selected analysis environment, the first results of the analysis to the distributor; sending, by the selected analysis environment, a VHD whose state has been infected by the execution of the object of analysis to the distributor; generating, by the distributor, second results of the analysis by comparing a state of the infected VHD with a state of the clean VHD, and analyzing, by the distributor, a change in the state between the states of the infected VHD and the clean VHD; and generating, by the distributor, results of malicious code analysis based on the first results of the analysis and the second results of the analysis.

The clean VHD may be generated by copying an original VHD or a child VHD.

The method may further include performing, by the selected analysis environment, restoration to a clean analysis environment using the clean VHD generated by copying an original VHD or a child VHD when a new analysis is started.

The clean VHD may be provided by the distributor.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the configuration of an overall system to which an embodiment of the present invention is applied, and also illustrating data which is transmitted and received between nodes;

FIG. 2 is a diagram illustrating the configuration of an apparatus for analyzing malicious code in a real environment according to an embodiment of the present invention;

FIG. 3 is a flowchart illustrating a method of analyzing malicious code in a real environment according to an embodiment of the present invention;

FIG. 4 is a diagram illustrating a process of using an original VHD and an infected VHD in an analysis procedure in the method of analyzing malicious code in a real environment using a fixed VHD or an expandable VHD;

FIG. 5 is a diagram illustrating the relationship between a parent VHD and a child VHD in the method of analyzing malicious code in a real environment using a differencing VHD; and

FIG. 6 is a diagram illustrating a process using a parent VHD and a child VHD in an analysis procedure in the method of analyzing malicious code in a real environment using a differencing VHD.

### DESCRIPTION OF THE PREFERRED EMBODIMENTS

The present invention may be subjected to various modifications, and may have various embodiments. Specific embodiments are illustrated in diagrams and described in detail.

However, this is not intended to limit the present invention to the specific embodiments, but it should be appreciated that all modifications, equivalents and replacements included in the spirit and technical range of the present invention fall within the range of the present invention.

The terms used herein are used merely to illustrate specific embodiments, and are not intended to limit the present invention. Unless otherwise stated clearly, a singular expression includes a plural expression. In the specification and claims, it should be understood that the term “comprise,” “include,” “have” and their variants are intended merely to designate the presence of features, numbers, steps, operations, elements, parts or combinations thereof described in the specification, and should not be construed as excluding the presence or additional probability of one or more different features, numbers, steps, operations, elements, parts or combinations thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments of the present invention are described in detail below with reference to the accompanying drawings. In the following description of the embodiments, the same reference numerals are assigned to the same elements throughout the drawings and also redundant descriptions of the same elements are omitted, in order to make the overall understanding easy.

In the specification of the present invention, a VHD enables a file to be recognized and used as a hard disk, and the internal structure of the VHD has been disclosed by Microsoft Co.

A VHD may also be used in a virtual environment, and is used as a hard disk image, for example, in Virtual-PC and Hyper-V.

The point to which attention was paid in the present invention is that, after a VHD has been generated in real hardware and an operating system has been installed, booting (i.e., native VHD booting) can be directly performed in the real hardware using the operating system installed on the VHD. When an analysis is performed in a virtual environment, a virtualized hardware device must be accessed. In contrast, in a real environment in which booting is performed using a VHD, a real hardware device is used, and thus malicious code determines that it is being executed in a real environment and then exhibits its intended malicious behavior. Accordingly, the behavior of the malicious code can be analyzed.

VHDs include three types of VHDs, as follows:

1) A fixed hard disk image type: the size of a corresponding VHD file is fixed and is not changed.

2) An expandable hard disk image type: a VHD file has a minimum size first, and the size of the VHD file is increased when it is necessary to increase a disk space.

3) A differencing hard disk image type: a parent VHD is generated as a fixed or expandable hard disk image type. Thereafter, only information about a part newly written on a differencing hard disk image type of VHD (i.e., a differencing VHD) or a part changed in the differencing VHD is recorded. If such a change is small with respect to the parent VHD, the size of a differencing VHD file is also small.

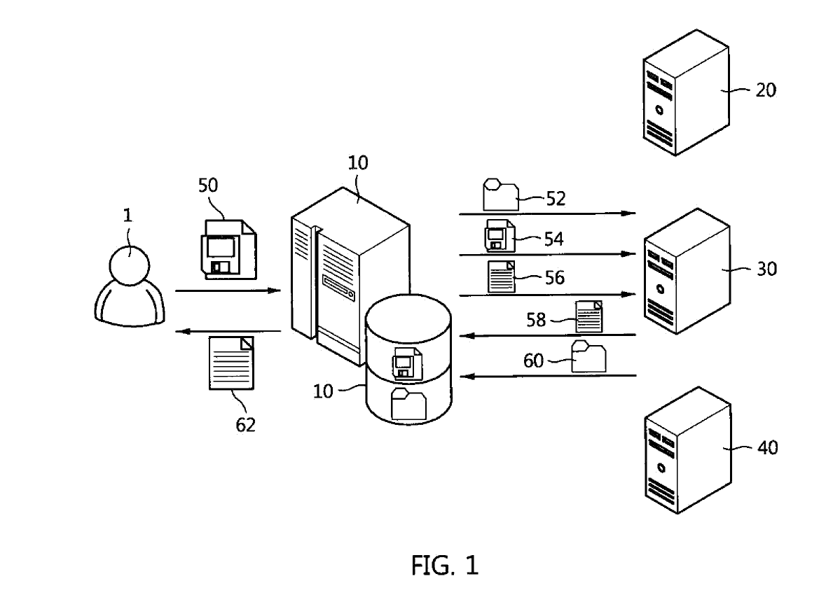

FIG. 1 is a diagram illustrating the configuration of an overall system to which an embodiment of the present invention is applied, and also illustrating data which is transmitted and received between nodes.

First, a user 1 transfers an object of analysis 50 to a distributor 10. The user 1 may be a real person, or may be another system that sends malicious code.

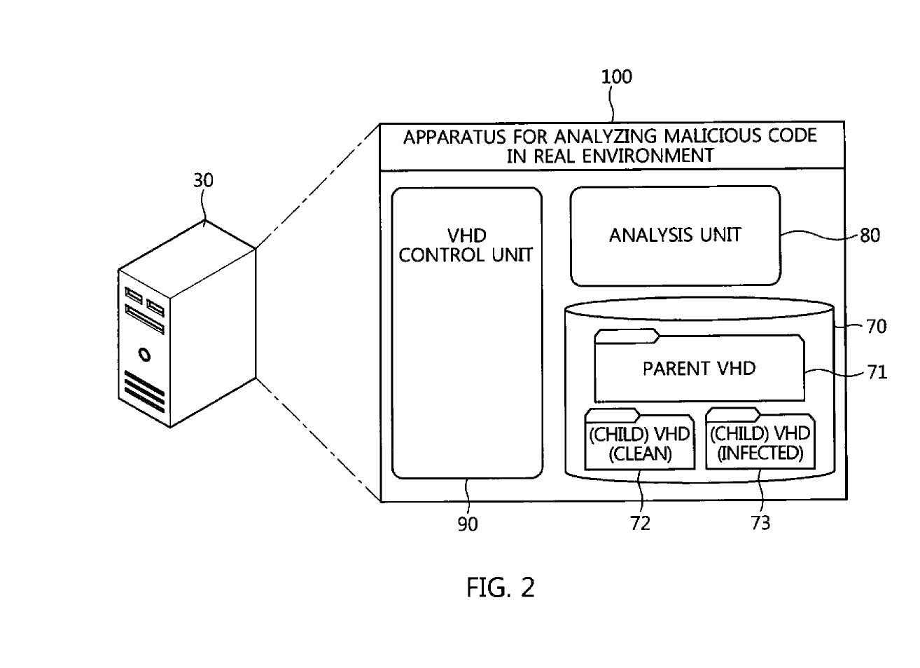

Thereafter, the distributor 10 selects an analysis environment (e.g., 30) in an idle state from among a plurality of analysis environments 20, 30 and 40 (e.g., PCs), and transfers a remote booting command 52 to the analysis environment 30. In this case, the remote booting includes booting over a network (not illustrated) and booting though a physical switch (not illustrated). Depending on the configuration of the system, the distributor 10 transfers a clean VHD 54 (or an original VHD) to be used for analysis to the analysis environment 30 over a network so that the analysis environment 30 may be booted using the clean VHD 54 or may be booted using a clean VHD (e.g., 72 in FIG. 2) stored in the analysis environment 30. In this case, the clean VHD means an uninfected VHD.

After the analysis environment 30 has been booted using the clean VHD 54, the distributor 10 transfers an object of analysis 56, received from the user 1, to the analysis environment 30.

Accordingly, the analysis environment 30 internally executes, monitors and analyzes the object of analysis 56, and transfers the results of analysis 58 to the distributor 10.

Furthermore, the analysis environment 30 transfers a disk image of the analysis environment 30 that is present after the object of analysis 56 has been executed, that is, an infected VHD 60, to the distributor 10.

Thereafter, the distributor 10 analyzes a change in the state between the clean VHD 54 (or the original VHD) and the infected VHD 60, and uses the analyzed change to detect malicious code.

The distributor 10 generates the results of malicious code analysis 62 by integrating the results of the analysis 58 produced by the analysis environment 30 and the results of the analysis based on the results of the comparison between the VHDs by the distributor 10, and transfers the results of the malicious code analysis 62 to the user 1 who has requested the analysis.

FIG. 1 illustrates that the analysis environment 30 transfers the results of the analysis 58 and the infected VHD 60 to the distributor 10, and the distributor 10 analyzes a change in the state between the clean VHD 54 and the infected VHD 60 and generates the results of the malicious code analysis 62. Alternatively, the analysis environment 30 may store the results of the analysis 58 therein without transferring the results of the analysis 58 to the distributor 10, may store the infected VI-ID 60 therein without transferring the infected VHD 60 to the distributor 10, analyze a change in the state between the clean VHD 54 (or the original VHD) and the infected VHD 60, and generate the results of the malicious code analysis 62. In this case, the final results of the malicious code analysis 62 may be generated by the analysis environment 30, and thus this case may be efficient in terms of configuration and data transmission and reception compared to the case where the distributor 10 and the analysis environment 30 present the respective results of the analysis and the distributor 10 analyzes the results of the analysis in an integrated manner.

FIG. 2 is a diagram illustrating the configuration of an apparatus for analyzing malicious code in a real environment according to an embodiment of the present invention. In FIG. 2, the apparatus 100 for analyzing malicious code in a real environment according to this embodiment of the present invention may be mounted on the analysis environments 20, 30, and 40.

The apparatus 100 for analyzing malicious code in a real environment according to this embodiment of the present invention includes a storage unit 70, an analysis unit 80, and a VHD control unit 90. Each of the storage unit 70, the analysis unit 80 and the VHD control unit 90 may be implemented in the form of modules.

The storage unit 70 stores an original VHD file and VHD files to be used or having been used for analysis. The storage unit 70 may store a parent VHD 71 and child VHDs 72 and 73. In this case, the parent VHD 71 may be referred to as an uninfected original VHD. The child VHD 72 has been generated by the parent VHD 71, and may be referred to as an uninfected VHD. A clean VHD generated by copying the child VHD 72 may be included in the child VHD 72. The child VHD 73 is a VHD that has been infected after the object of analysis has been executed.

The analysis unit 80 performs various analyses. That is, the analysis unit 80 executes the object of analysis 56 received through the distributor 10, and generates the results of the analysis 58 by performing the static, dynamic and state analyses of the object of analysis 56. Furthermore, the analysis unit 80 generates the results of the comparison between the clean VHD 72 (or the original VHD) of the storage unit 70 and the infected VHD 73 by performing comparison and analysis on the clean VHD 72 and the infected VHD 73.

Furthermore, the analysis unit 80 generates the results of the malicious code analysis 62 by integrating the results of the analysis 58 and VHD and the results of the comparison.

The VHD control unit 90 stores the parent VHD 71, the clean VHD 72, and the infected VHD 73 in the storage unit 70. The VHD control unit 90 performs booting using the clean VHD 72 or the parent VHD 71 stored in the storage unit 70 in response to an external remote booting command. The VHD control unit 90 controls the operation of the analysis unit 80, and sends the results of the malicious code analysis 62 of the analysis unit 80 to the user 1 through the distributor 10. The VHD control unit 90 prepares a clean VHD file for a target analysis environment, and performs booting, thereby enabling restoration to a clean VHD file.

That is, the VHD control unit 90 may be viewed as performing a variety of types of control on a VHD file.

In FIG. 2, the storage unit 70 and the VHD control unit 90 have been illustrated as being configured to independent from each other, but the storage unit 70 may be included in the VHD control unit 90.

Meanwhile, if the distributor 10 is able to analyze a change in the state between a clean VHD and an infected VHD and to generate the results of malicious code analysis, a function that belongs to the functions of the analysis unit 80 and that corresponds to the function of analyzing a change in the state between a clean VHD and an infected VHD and generating the results of malicious code analysis may be removed.

In the present invention, in the comparison of the state of an infected VHD with the state of a clean VHD and the analysis of a change in the state between the clean VHD and the infected VHD, not only a method using a fixed VHD or an expandable VHD but also a method using a differencing VHD may be used.

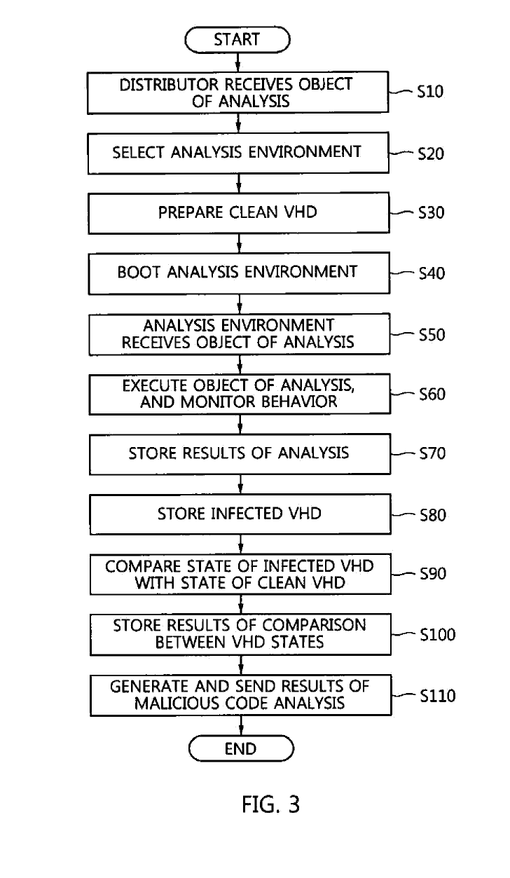

FIG. 3 is a flowchart illustrating a method of analyzing malicious code in a real environment according to an embodiment of the present invention. In the following description of FIG. 3, it is assumed that an analysis environment stores the results of analysis obtained by performing the static, dynamic and state analyses of an object of analysis, stores an infected VHD, analyzes a change in the state between a clean VHD and an infected VHD, and generates the results of malicious code analysis by integrating the results of the analysis and the results of the comparison between the states of the clean VHD and the infected VHD.

The object of analysis is transferred to the distributor 10 by the input of the user 1 or a separate system at step S10. In this case, the object of analysis may be an executable file, and may be an image file, a document file, or a suspicious URL.

After the distributor 10 has received the object of analysis, the distributor 10 selects an apparatus for analyzing malicious code in a real environment (i.e., an analysis environment) in which the object of analysis will be executed at step S20. This is performed to select an apparatus for analyzing malicious code in a real environment in an idle state because a plurality of apparatuses for analyzing malicious code in a real environment (e.g., 20, 30, and 40 in FIG. 1) is present.

After the analysis environment has been selected, the VHD control unit 90 of the analysis environment prepares a clean VHD file for the analysis environment in order to boot the analysis environment at step S30. In this case, the task of restoring an infected VHD file to a clean VHD file may be executed after step S20, along with step S80 of storing an infected VHD, or may be executed after step S70 of storing the results of the analysis.

After the clean VHD file for booting has been prepared, the VHD control unit 90 boots the apparatus for analyzing malicious code in a real environment (i.e., the analysis environment) using the prepared clean VHD file at step S40.

After the selected apparatus for analyzing malicious code in a real environment (i.e., the selected analysis environment) has been booted, the object of analysis received from the outside at step S10 is transmitted to the selected analysis environment at step S50. In this case, the object of analysis is transferred to the analysis unit 80 of the selected analysis environment.

When the object of analysis is prepared as described above, the analysis unit 80 of the selected analysis environment executes the object of analysis and then performs the static, dynamic and state analyses of the object of analysis at step S60.

After the analyses have been terminated, the analysis unit 80 temporarily stores the results of the analysis at step S70. If the distributor 10 has the function of generating the results of malicious code analysis, the results of the analysis may be transmitted to the distributor 10 at step S70.

Furthermore, the analysis unit 80 stores a VHD whose state has been infected by the execution of the object of analysis in the storage unit 70 at step S80. If the distributor 10 has the function of generating the results of malicious code analysis, the VHD infected at step S80 may be transmitted to and stored in the distributor 10.

Thereafter, the analysis unit 80 compares the state of the infected VHD with the state of the clean VHD and analyzes a change in the state between the clean VHD and the infected VHD at step S90. In this case, if a differencing VHD has been used, information about parts changed in a clean environment is included in the infected VHD. The change that has been applied to the analysis environment by malicious code may be determined based on only the infected VHD without comparing the infected VHD with the clean VHD. If the distributor 10 has the function of generating the results of malicious code analysis, the comparison between the clean VHD and the infected VHD and the analysis of a change in the state between the clean VHD and the infected VHD performed at step S90 may be performed by the distributor 10.

Thereafter, at step S100, the analysis unit 80 temporarily stores the results of the comparison between the states of the infected and clean VHDs at step S90. If the distributor 10 has the function of generating the results of malicious code analysis, the results of the comparison between the states of the VHDs may be temporarily stored in the distributor 10.

Finally, the analysis unit 80 generates the results of malicious code analysis by integrating the results of the analysis at step S70 and the results of the comparison between the states of the VHDs at step S90. The VHD control unit 90 transfers the generated results of the malicious code analysis to the user 1 who has requested the analysis at step S110. If the distributor 10 has the function of generating the results of malicious code analysis, the distributor 10 may generate the results of the malicious code analysis by integrating the results of the analysis at step S70 and the results of the comparison between the states of the VHDs at step S90.

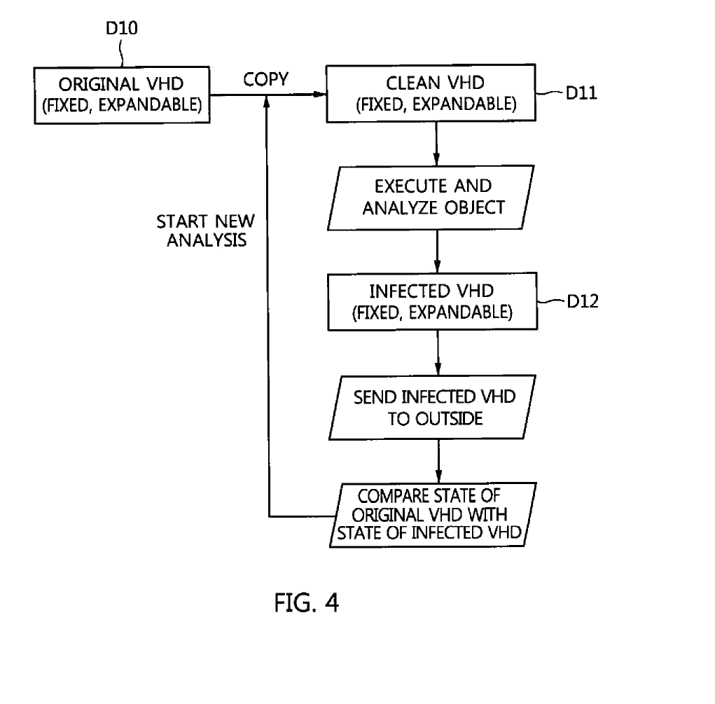

FIG. 4 is a diagram illustrating the process of using an original VHD and an infected VHD in the analysis procedure in the method of analyzing malicious code in a real environment using a fixed VHD or an expandable VHD.

When a new analysis starts, a copied VHD (i.e., a clean VHD) D11 generated by copying the original VHD D10 having no changed part is generated, and booting is performed using the copied VHD D11.

After the analysis has been terminated, a corresponding VHD (i.e., an infected VHD) D12 has been changed by the object of analysis. Therefore, the infected VHD D12 is separately stored for a state analysis or transmitted outside the apparatus 100 for analyzing malicious code in a real environment. In this case, sending the infected VHD D12 outside the apparatus 100 for analyzing malicious code in a real environment means that the distributor 10 is capable of analyzing a change in the state between the original VHD D10 (or the clean VHD D11) and the infected VHD D12. If the analysis unit 80 of the apparatus 100 for analyzing malicious code in a real environment is able to analyze a change in the state between the original VHD D10 (or the clean VHD D11) and the infected VHD D12, the infected VHD D12 does not need to be transmitted outside the apparatus 100 for analyzing malicious code in a real environment.

When a new analysis starts again, booting is performed using a copied VHD D11 generated by copying the original VHD D10, and a clean analysis environment is constructed.

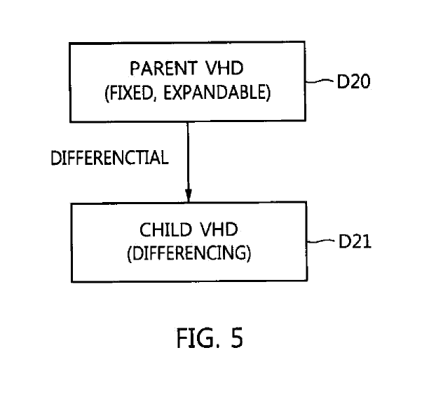

FIG. 5 is a diagram illustrating the relationship between a parent VHD and a child VHD in the method of analyzing malicious code in a real environment using a differencing VHD.

A parent VHD D20 is generated as a fixed or expandable type, and is set as a clean analysis environment. A child VHD D21 is generated as a differencing type with respect to the parent VHD D20. When an analysis is performed, the child VHD D21 is booted using the child VHD D21, thereby constructing an environment.

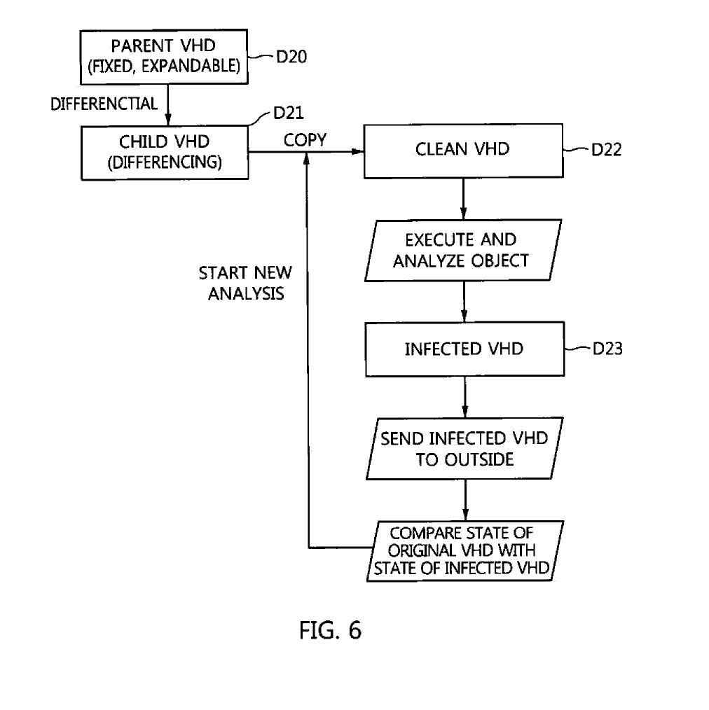

FIG. 6 is a diagram illustrating a process using a parent VHD and a child VHD in the analysis procedure in the method of analyzing malicious code in a real environment using a differencing VHD.

When a new analysis starts, a clean VHD D22 is generated by copying the child VHD D21 having no changed part, and booting is performed using the clean VHD D22.

After the analysis has been terminated, a corresponding VHD (i.e., an infected VHD) D23 is separately stored or is transmitted outside a real analysis environment for a state analysis because it has been changed by the object of analysis. In this case, sending the infected VHD D23 outside the real analysis environment means that the distributor 10 is capable of analyzing a change in the state between the original VHD (or the clean VHD D22) and the infected VHD D23. If the analysis unit 80 of the apparatus 100 for analyzing malicious code in a real environment is able to analyze a change in the state between the original VHD (or the clean VHD D22) and the infected VHD D23, the infected VHD D23 does not need to be transmitted outside the real analysis environment.

When a new analysis starts again, booting is performed using a copied clean VHD D22 generated by copying the child VHD D21 having no changed part, and a clean analysis environment is constructed.

As described above, in accordance with at least one embodiment of the present invention, the behavior of malicious code that recognizes an environment as a virtual environment and does not maliciously act in connection with conventional malicious code analysis methods and systems using a virtual environment can be monitored and analyzed. Accordingly, the at least one embodiment of the present invention has the significant advantage of improving the detection ratio of malicious code of a malicious code analysis and detection system.

Furthermore, in the construction of a real environment analysis system, the greatest obstacle to the construction of a real environment analysis system can be overcome because an image storage space and network resources and time required for image restoration in connection with the restoration (i.e., restoration to a clean environment) and storage (i.e., the storage of an infected environment) of an analysis environment are effectively reduced.

In other words, in accordance with at least one embodiment of the present invention, malicious code is analyzed in real hardware (i.e., a real environment) using a VHD. As techniques for analyzing malicious code have been known recently, the ratio of malicious code that recognizes virtual environments and do not operate is increased. Therefore, if the present invention is used, the ratio of detection of these types of malicious code can be increased.

Furthermore, in accordance with at least one embodiment of the present invention, the greatest problem in the construction of a malicious code analysis system in a real environment can be solved because a restored image storage space and the time required for restoration can be significantly reduced in the process of performing restoration to the state prior to the execution of a sample in a real environment analysis system.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for analyzing malicious code in a real environment, comprising:
a storage unit configured to store an original virtual hard disk (VHD) and a child VHD;
a VHD control unit configured to perform booting using an uninfected clean VHD, and to output received results of malicious code analysis to an outside; and
an analysis unit configured to execute an external object of analysis after the booting, to generate first results of the analysis based on static, dynamic and state analyses of the object of analysis, to generate second results of the analysis by comparing a state of an infected VHD whose state has been infected by the execution of the object of analysis with a state of the clean VHD and then analyzing a change in the state between the infected VHD and the clean VHD, to generate results of malicious code analysis based on the first results of the analysis and the second results of the analysis, and to send the results of the malicious code analysis to the VHD control unit.

2. The apparatus of claim 1, wherein the VHD control unit is further configured to perform the booting using the clean VHD generated by copying the original VHD when the booting is executed.

3. The apparatus of claim 1, wherein the VHD control unit is further configured to perform the booting using the clean VHD generated by copying the child VHD when the booting is executed.

4. The apparatus of claim 1, wherein the VHD control unit is further configured to store, in the storage unit, the infected VHD whose state has been changed after the execution of the object of analysis in the analysis unit.

5. The apparatus of claim 1, wherein the VHD control unit is further configured to perform restoration to a clean analysis environment using the clean VHD that is generated by copying the original VHD when a new analysis is started by the analysis unit.

6. The apparatus of claim 1, wherein the VHD control unit is further configured to perform restoration to a clean analysis environment using the clean VHD generated by copying the child VHD when a new analysis is started by the analysis unit.

7. The apparatus of claim 1, wherein the original VHD is generated as a fixed or expandable hard disk image type.

8. The apparatus of claim 7, wherein the child VHD is generated as a differencing hard disk image type.

9. The apparatus of claim 1, wherein the analysis unit generates the second results of the analysis based on the change in the state of the infected VHD if the clean VHD is of a differencing hard disk image type when comparing the state of the infected VHD with the state the clean VHD and then analyzing the change in the state between the infected VHD and the clean VHD.

10. The apparatus of claim 1, wherein the object of analysis comprises one or more of an executable file, an image file, a document file, and a uniform resource locator (URL).

11. A method of analyzing malicious code in a real environment, comprising:
performing, by a virtual hard disk (VHD) control unit, booting using an uninfected clean VHD;
executing, by an analysis unit, an external object of analysis after the booting;
generating, by the analysis unit, first results of the analysis based on static, dynamic and state analyses of the object of analysis;
generating, by the analysis unit, second results of the analysis by comparing a state of an infected VHD whose state has been infected by the execution of the object of analysis with a state of the clean VHD and also analyzing a change in the state between the infected VHD and the clean VHD; and
generating, by the analysis unit, results of malicious code analysis based on the first results of the analysis and the second results of the analysis.

12. The method of claim 11, wherein performing the booting comprises performing the booting using the clean VHD generated by copying an original VHD.

13. The method of claim 11, wherein performing the booting comprises performing the booting using the clean VHD generated by copying a child VHD.

14. The method of claim 11, further comprising performing, by the VHD control unit, restoration to a clean analysis environment using the clean VHD generated by copying an original VHD when a new analysis is started.

15. The method of claim 11, further comprising performing, by the VHD control unit, restoration to a clean analysis environment using the clean VHD generated by copying a child VHD when a new analysis is started by the analysis unit.

16. The method of claim 11, wherein generating the second results of the analysis comprises generating the second results of the analysis based on the change in the state of the infected VHD if the clean VHD is of a differencing hard disk image type when comparing the state of the infected VHD with the clean VHD and also analyzing the change in the state between the infected VHD and the clean VHD.

17. A method of analyzing malicious code in a real environment, comprising:
selecting, by a distributor, any one of a plurality of analysis environment that are real hardware;
performing, by the selected analysis environment, booting using an uninfected clean virtual hard disk (VHD);
transferring, by the distributor, an object of analysis to the selected analysis environment after performing the booting;
generating, by the selected analysis environment, first results of the analysis based on the static, dynamic and state analyses of the object of analysis by executing the object of analysis;
sending, by the selected analysis environment, the first results of the analysis to the distributor;
sending, by the selected analysis environment, a VHD whose state has been infected by the execution of the object of analysis to the distributor;
generating, by the distributor, second results of the analysis by comparing a state of the infected VHD with a state of the clean VHD, and analyzing, by the distributor, a change in the state between the states of the infected VHD and the clean VHD; and
generating, by the distributor, results of malicious code analysis based on the first results of the analysis and the second results of the analysis.

18. The method of claim 17, wherein the clean VHD is generated by copying an original VHD or a child VHD.

19. The method of claim 17, further comprising performing, by the selected analysis environment, restoration to a clean analysis environment using the clean VHD generated by copying an original VHD or a child VHD when a new analysis is started.

20. The method of claim 17, wherein the clean VHD is provided by the distributor.
